(19) United States
(12) Patent Application Publication
(10) Pub. No.: US 2025/0250137 A1
(43) Pub. Date: Aug. 7, 2025

(54) Conveyor System with Adjustable Flight Intervals

(71) Applicant: BW Converting, Inc., Green Bay, WI (US)

(72) Inventors: Jacob Liimatta, De Pere, WI (US); Jamie Heroux, Gillett, WI (US)

(21) Appl. No.: 19/014,691

(22) Filed: Jan. 9, 2025

Related U.S. Application Data
(60) Provisional application No. 63/548,943, filed on Feb. 2, 2024.

(51) Int. Cl. B65H 20/06; B65H 35/00

(52) U.S. Cl. CPC B65H 20/06; B65H 35/0086; B65H 2404/25; B65H 2404/261; B65H 2701/1123; B65H 2701/139

(57) ABSTRACT

A conveyor system for moving stacked webs of material has a first unit with at least three belts. Each belt is driven by a motor having a drive shaft with a pulley. The drive shaft of one motor is spaced from the drive shaft of another motor to define a routing along which the belts travel in parallel paths and are independently movable. Each belt has at least two product supports. A second unit is opposite of the first unit and forms a process zone with the first unit. In the process zone, the product support of one of the belts of the first unit engages one side of the stacked web material, and the second unit engages an opposite side of the stacked web material. The product supports move in a synchronized manner from an inlet to an outlet of the process zone at an adjustable interval.

### RELATED APPLICATION DATA

This application claims priority benefit to U.S. provisional application Ser. No. 63/548,943 filed Feb. 2, 2024, the disclosure of which is incorporated by reference herein.

### BACKGROUND AND SUMMARY

The present disclosure is directed to a conveyor system for a converting process. More in particular, the disclosure is directed to a conveyor system for conveying folded, stacked webs of material presented in a ribbon format, for instance, facial tissue, wet wipes, dry wipes, etc. The material may be folded and stacked in a Z arrangement, W arrangement or another arrangement, as may be desired. The height (i.e., thickness) and the overall length of the ribbon may vary as may be desired. More in particular, the disclosure relates to a conveyor system for such material used in connection with a saw where the conveyor system has adjustable flight intervals, for instance, adjustable supports that support the ribbon during the cutting cycle with the saw. The flight supports may be adjustably spaced at desired intervals so as to allow a portion of the ribbon to be cut-off to a desired length in the saw cutting operation. The intervals may be set to provide clearance between the saw blade and the flight supports of the conveyor system. The intervals may vary from job to job, depending upon the processing parameters and the desired length of the portion to be cut from the ribbon.

### DESCRIPTION OF THE DRAWINGS

FIG. 1 shows a side view of one embodiment of a conveyor system including a saw positioned within the conveyor system with a portion of a frame of the conveyor system removed for purposes of illustrating detail of the conveyor system.

FIG. 2 is a sectional view of the conveyor system taken along lines 2-2 of FIG. 1 showing a saw path for the saw relative to the frame of the conveyor system.

FIG. 3 shows a side view of another embodiment of the conveyor system.

FIG. 4 shows an end view of the conveyor system of FIG. 3.

FIG. 5 shows a perspective view of a lower unit of the conveyor system of FIG. 3.

FIG. 6 shows a perspective view of a lower unit of another embodiment of the conveyor system of FIG. 3 without a primary unit and instead an upper guide conveyor.

FIG. 6 also demonstrates the use of product supports to support the ribbon in the process zone whether in connection with the conveyor system of FIG. 3 or the alternate embodiment with the lower unit, and with the upper unit replaced by a guide conveyor.

FIG. 7 illustrates the placement of product supports on belts of the conveyor system of FIG. 3.

FIG. 8 is a plan view of another embodiment of the product support used on a belt of the conveyor system of FIG. 3 comprising two spaced apart arms attachable to the belt as a unitary or single member.

FIG. 9 is a perspective view of a product support used on a belt of the conveyor system of FIG. 3 comprising two spaced apart arms separately attachable to the belt.

FIG. 10 is a chart illustrating engineering data given length of clip products and a number of product supports per clip product.

FIG. 11 is a schematic side elevation of a single support pitch length of belt of the conveyor system of FIG. 3, shown stretched out horizontally for illustration purposes, in which product supports have a target phase offset which results in interdigitated (interlaced) adjacent product supports within the process zone.

FIG. 12 is a schematic side elevation of a single support pitch length of belt of the conveyor system of FIG. 3, shown stretched out horizontally for illustration purposes, in which product supports have a target phase offset which results in gaps between adjacent product supports within the process zone.

FIG. 13 is a graph showing exemplary product support motion profiles.

### DETAILED DESCRIPTION

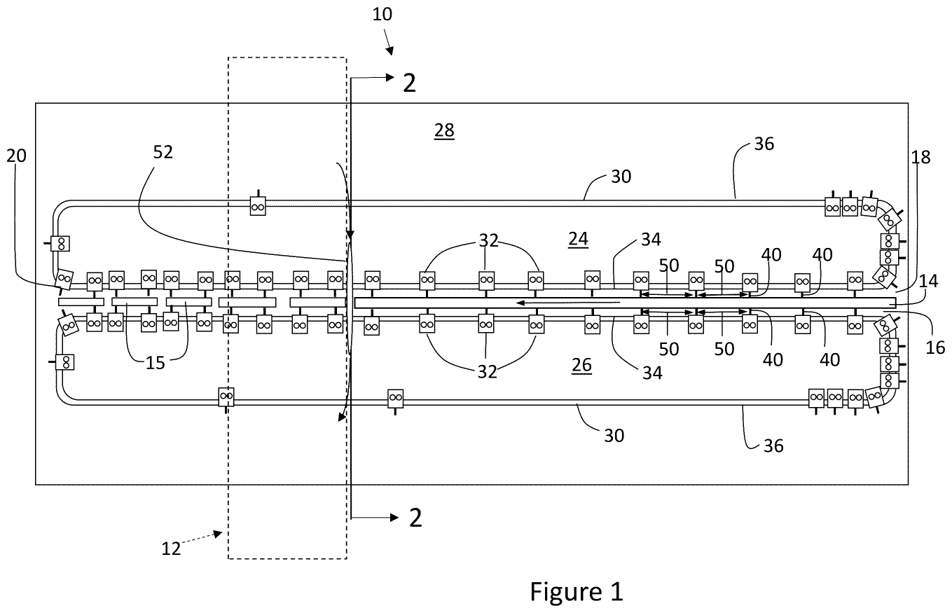

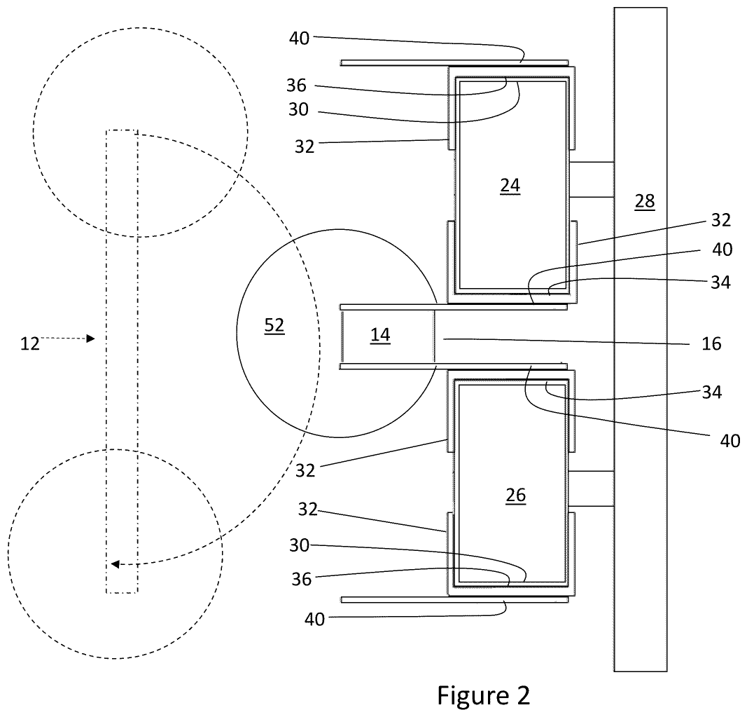

FIGS. 1 and 2 show an exemplary conveyor system 10 used in connection with a saw 12. The conveyor system 10 may be used in a converting process for conveying folded, stack webs of material 14, e.g., ribbons, toward the saw 12 for a saw cutting operation to form clips 15. The conveyor system 10 may have one lane 16 as shown, or may have multiple lanes like that shown arranged side-by-side. Each lane 16 of the conveyor system may have an inlet 18 at one end of the conveyor system and a discharge 20 at an opposite end of the conveyor system. The saw 12 may be arranged generally in the center of the conveyor system 10 for cutting off longitudinal portions of the ribbon into desired lengths (clips 15) as the product is conveyed on the conveyor, as will be described below in greater detail. While the description and drawings show a generally rectangularly shaped folded, stacked web of material comprising the ribbon 14, the principles of the disclosure may be applied to convolutely wound web material in the form of a log with or without a core, for instance, as commonly presented in connection with toilet tissue, kitchen towels, or other rolled paper products. In that regard, the saw may be arranged at the discharge of the conveyor.

The conveyor system 10 may have a first linear motion conveyor 24 and a second linear motion conveyor 26. As shown in the drawings, the first linear motion conveyor 24 is arranged on an upper portion of a frame 28 of the conveyor system and the second linear motion conveyor 26 of the lane is arranged on the bottom of the frame of the conveyor system. The linear motion conveyors 24,26 are generally the same, and each has a track 30 with a plurality of movers 32 adapted and configured to move on the track. Each mover 32 may be magnetically propelled on the track and may be configured for motion independent of the motion of another mover on the track. The linear motion conveyors may be of the type provided by Rockwell Automation under the brand-name I-TRAK™. The linear motion conveyor may have a straight portion of the track and a curved portion of the track. The term linear motion is not limited to motion on the straight portion of the track and includes motion on the curved portion of the track. Each track 30 may have a transport run 34 extending along the direction of advancement of the ribbon in the conveyor system, and a return run 36 extending in a direction opposite to the direction of advancement. The transport runs 34 of the tracks 30 of the first and second linear motion conveyors 24,26 may be arranged parallel to each other and with a spacing (e.g., vertical height) that accommodates different ribbon heights (e.g., folded webs stack heights, log diameter) depending upon the application and the nature of the ribbon or log being processed. At least one of the linear motion conveyors 24,26 may be positionable relative to the other on the frame 28 so as to change the spacing (e.g., vertical distance in the drawings) between the transport runs 34. Preferably, the upper linear conveyor 24 is movable while the lower linear conveyor is fixed in height to adjust the spacing between the transport runs of the tracks, so that the lower conveyor remains at the same height as equipment upstream and downstream of the conveyors. Alternatively, both linear motion conveyors 24,26 are movable, on the frame 28 of the conveyor system to adjust the spacing between the transport runs of the tracks.

The movers 32 on the linear motion conveyors work together when on the transport runs 34 of the respective tracks 30 to advance ribbon 14 from the inlet 18 of the lane 16 of conveyor system to the discharge 20 of the lane of the conveyor system. When on the return runs 36 of the respective tracks, the movers 32 may be configured to move independently of one another and be positioned in a queue adjacent to the inlet 18 of the lane 16. It should be appreciated that at any one time, there may be only some of the plurality of movers on the transport run 34 of the track 30. The other movers may be positioned in queue adjacent to the return run 36 of the track 30. Each of the movers 32 on the track 30 of the first linear motion conveyor 24 and each of the movers 32 on the track 30 of the second linear motion conveyor 26 may have one or more flight supports 40 projecting outward in a direction away from their respective track. The flight supports 40 may be adapted and configured to engage surfaces (e.g., in the drawings, the top and bottom surfaces) of the ribbon 14. The flights supports may have flat outer surfaces that extend along the direction of advancement of the ribbon so as to sufficiently engage the top and bottom surface of the ribbon, stabilize the ribbon during cutting with the saw and advance the ribbon and the clips 15 of the ribbon. The spacing (e.g., vertical distance in the drawings) of the first linear motion conveyor 24 and the second linear motion conveyor 26 can be adjusted to enable the flight supports 40 of the movers 32 on the transport runs 34 of the first and second tracks 30 to engage the respective sides of the ribbon 14 in the lane 16.

Depending upon the configuration of the conveyor system, there may be dedicated linear motions conveyors, and thus dedicated movers and flight supports, for each lane 16 (whether in a one lane conveyor system or a multi-lane conveyor system). In the alternative, the flight supports may span across multiple lanes of the conveyor system so one linear motion conveyor and its respective movers advance the ribbon in more than one lane. For instance, two upper linear motion conveyors and two lower linear motion conveyors may have movers with flight supports that advance the ribbons disposed in four lanes with the flight supports and movers then on the transport run of each of the respective tracks of the upper and lower linear motion conveyors advancing the ribbons disposed in two of the lanes.

There also may be other devices in addition to the movers configured to travel on the track, for instance, a ribbon advancement member that engages the ribbon at the inlet of the lane of the conveyor system to assist in advancing the ribbon toward the discharge of the lane of the conveyor system. Such other devices may have other features that may or may not engage the outer surfaces of the ribbon, for instance, the devices may engage the axial end surface of the ribbon to push the ribbon from the inlet of the lane of the conveyor system toward the discharge of the lane of the conveyor.

The flight supports 40 of the movers 32 on the transport run 34 of each track 30 engage the outer surface of the ribbon and advance it from the inlet 16 of the lane of the conveyor system to the saw for cutting. Once clips 15 of the ribbon are cut, the flight supports 40 may advance the clips 15 toward the discharge 20 of the lane of the conveyor system. The movers 32 on the first track transport run and the movers on the second track transport run may be adapted and configured to move in a synchronized and aligned manner (i.e., have the same position in the direction of advancement of the conveyor system) from the inlet 18 of the lane 16 of the conveyor system to the discharge 20 of the lane of the conveyor system. In this way, the flight support 40 extending outward from the mover 32 then on the transport run 34 of the first track 30 may be aligned with the flight support extending outward from the mover then on the transport run of the second track to accommodate the ribbon height and to provide clearance for the blade of the saw while supporting the ribbon during the cutting cycle with the blade. Additionally, an interval of spacing between one mover on the transport run of the track and the next in line mover may be set, and may also be synchronized and aligned as between the first and second track. The interval 50 established between the movers 32 (and thus the flight supports 40) along the transport runs 34 of the tracks may correspond to a length of the clips 15 from the ribbon. The interval 50 may be sized to provide clearance between a blade 52 of the saw 12 and the flight supports 40 and the movers 32 when the blade of the saw is positioned in the lane of the conveyor system for cutting the ribbon.

The blade 52 of the saw 12 may be adapted for orbital motion relative to the conveyor system 10 or may be configured for reciprocating motion relative the conveyor. The saw 12 may be configured for stationary motion relative to the direction of advancement of the ribbon. The saw 12 may continuously cut the ribbon as the ribbon is advanced on the conveyor. The saw 12 may be in accordance with U.S. Pat. No. 6,123,002, the disclosure of which is incorporated by reference. Accordingly, the saw blade 52 may move in the direction of advancement of the ribbon as it orbits into the lane for cutting to account for the speed of advancement of the ribbon and the width of the ribbon while simulating a square end cut for the ribbon. Alternatively, the conveyor system 10 may be configured to intermittently advance the ribbon 14. For instance, during a cut cycle, the advancement of the ribbon 14 may be temporarily stopped to allow the saw blade 52 to start its cut and then exit the ribbon. Once the saw blade 52 exits the ribbon, the ribbon 14 may be advanced to establish the desired length for the successive portion of the ribbon to be cut to form the clip 15. To increase throughput, the advancement may occur as soon as the blade 52 exits the ribbon and while the saw 12 repositions the blade 52 to begin the new cut cycle on the successive portion of the ribbon. In an alternate embodiment, the saw 12 may be configured for linear motion in the direction of advancement of the ribbon 14. Accordingly, the conveyor system 10 may be configured to advance the movers 40 then on the transport run 34 of the tracks 30 of the linear motion conveyors 24,26 during the cutting cycle at a speed corresponding to the linear motion speed of the saw 12. After the blade 52 of the saw has exited the ribbon 14 after its cutting cycle, the rate of advancement of the clips 15 of the ribbon may increase to the discharge 20 of the conveyor.

When processing jobs change and the ribbon to be processed has a different cut off length, which necessitates a change of the interval 50 for the flight supports 40, the conveyor system 10 may be programmed via a human machine interface (HMI) associated with the conveyor system to change the interval between the movers 32 (and thus the flight supports 40) on the transport runs 34 of the first and second tracks 30 of the linear motion conveyors 24,26. Additionally, when the ribbon to be processed has a different thickness, which necessitates a change of spacing of the flight supports 40, the conveyor system 10 may be programmed with the human machine interface (HMI) to change the spacing between the transport runs 34 of the tracks 30 of the first and second linear motion conveyors 24,26.

While the drawings show the conveyor system 10 being used in connection with a saw 12, the principles described herein may be used in connection with any cutting system. Likewise, the flight supports 40 may be shaped to engage the shape of the material being conveyed. For instance, the flight supports may be generally flat and rectangular in shape so as to engage across the flat surface of a rectangularly shaped ribbon 14. The flight supports may also be curved so as to engage a cylindrical outer surface of a log of convolutely wound web material.

The linear motion conveyors 24,26 of the conveyor system 10 may be adapted and configured to sense malfunction or improper advancement of the ribbon through the conveyor system. The linear motion conveyors 24,26 of the conveyor system 10 may be adapted and configured to sense force and/or torque applied to a mover on the transport run 34 of the track 30 of the linear motion conveyor 24,26. The linear motion conveyors 24,26 of the conveyor system 10 may be adapted and configured to sense the position of a mover on the transport run 34 and/or return run 36 of the track 30 of the linear motion conveyor 24,26 to ensure a sufficient number of the movers are available to engage the ribbon or a successive ribbon in queue at the inlet 18 of the lane 16.

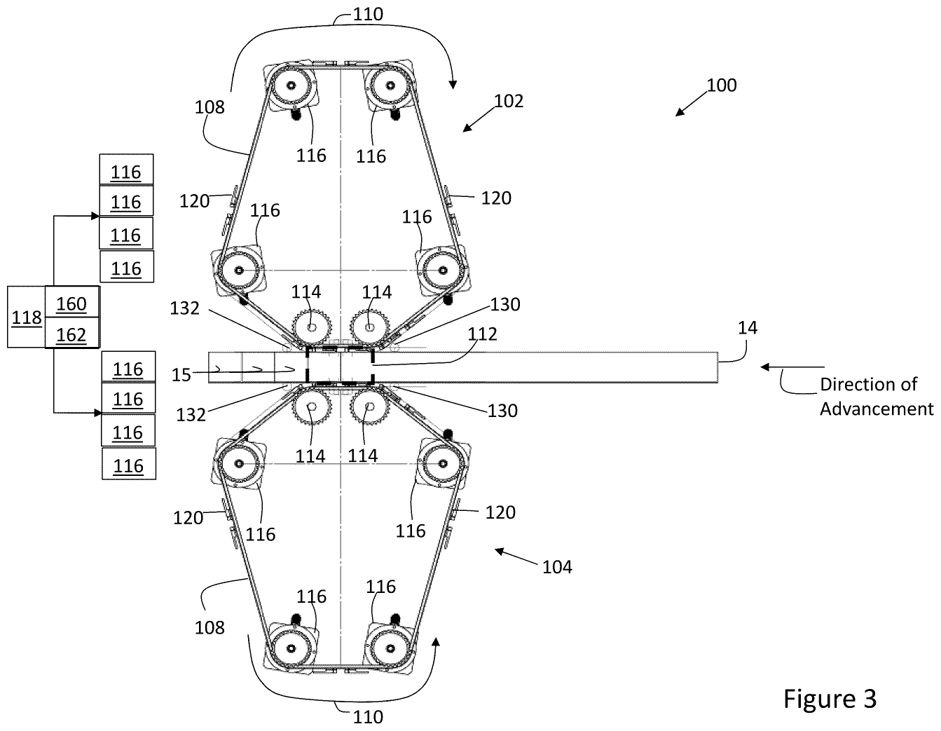

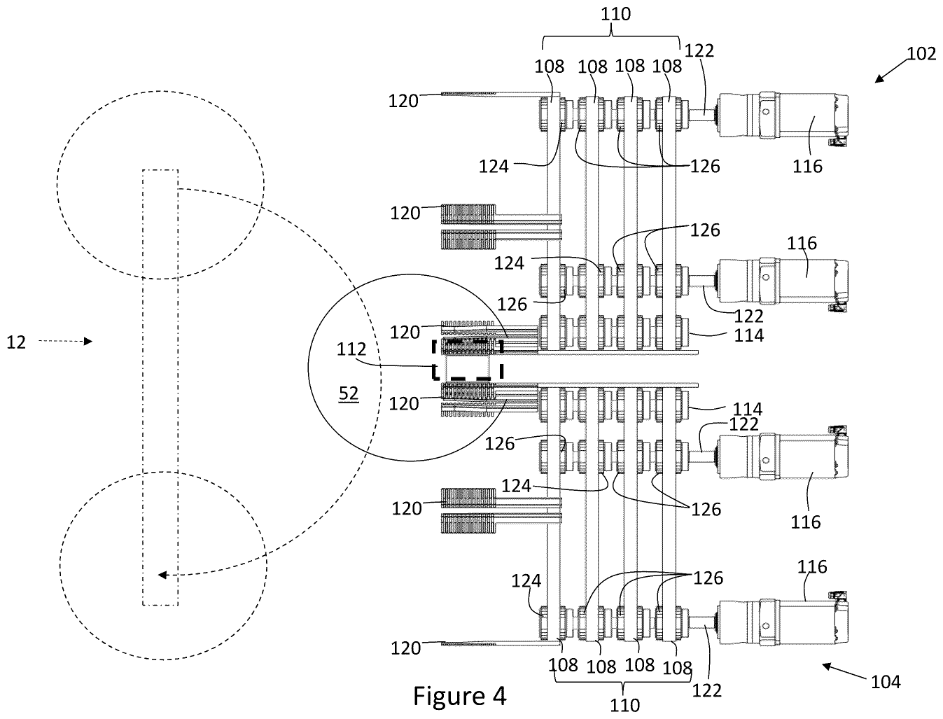

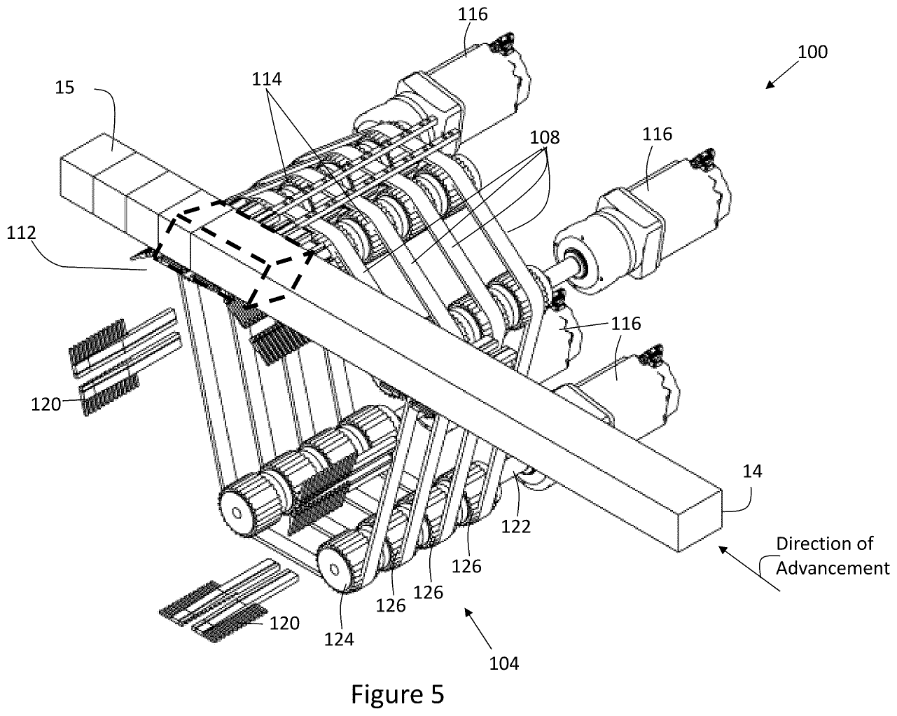

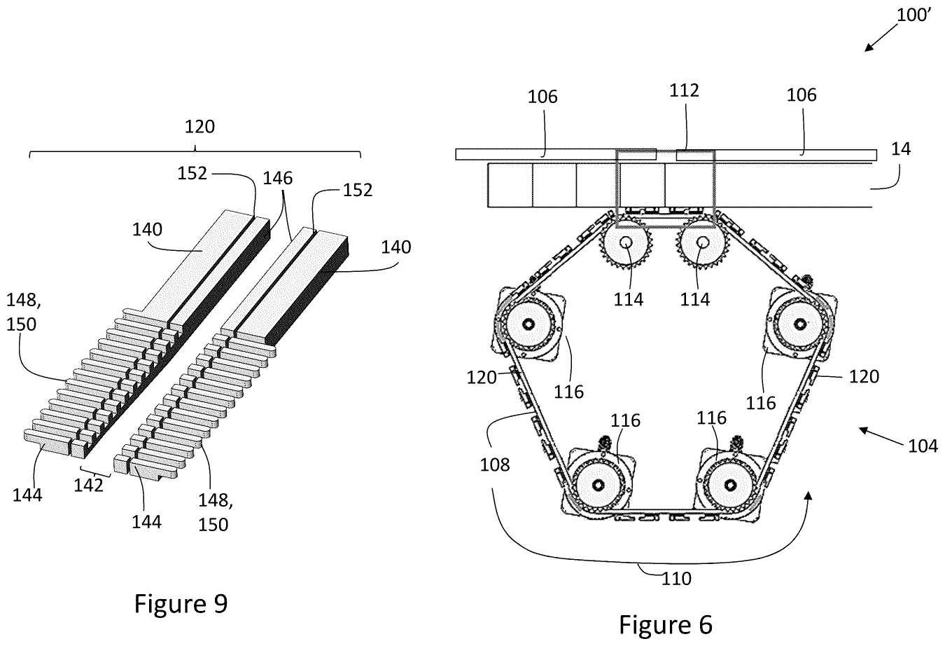

FIGS. 3-9 show other embodiments of a conveyor system 100, 100′ with an upper unit 102 and a lower unit 104 having belt systems with adjustable interval flights. The terms “upper”, “lower”, “first,” “second,” “primary,” and “secondary” are used for ease of differentiation among the various parts of the conveyor system, and not intended to be used in any limiting fashion as to position or importance. As shown in the drawings, the upper and lower units 102, 104 are constructed in a similar manner, and arranged opposite to each other with the ribbon 14 travelling therebetween. However, depending upon the application, one of the upper unit or lower unit 102,104 may have the belt system with adjustable interval flights and the other of the upper unit or lower unit may comprise a system of guide rails or conveyors 106 to maintain positioning of the ribbon 14 (See, e.g., FIG. 6). The belt system of a unit 102,104 comprises parallel flighted belts 108 that are arranged with a routing 110 in the unit. A portion of the routing of a respective unit defines a process zone 112 in which the flight supports 40 are engaged with the ribbon 14 and clips 15. For instance, as shown in the drawings, the upper and lower units 102, 104 are like constructed with each having a portion of the routing 110 of the belts 108 of the respective unit defining the process zone 112. A portion of the routing 110 of the belts 108 of each unit may include idler pulleys 114 that define the inlet and outlet of the process zone 112.

Each flighted belt 108 of a respective unit is driven independently of another flighted belt of the unit by its own separate and dedicated drive motor 116. A controller 118 is coupled to each drive motor 116 and is adapted and configured to control the respective drive motor in a manner to move the respective belt or continuous loop 108 of a unit 102,104 such that a product support connected to the respective belt moves from an inlet of a process zone to an outlet of the process zone. The controller 118 is adapted to move each belt 108 of a unit 102,104, and thus a product support 120 connected to the belt 108, independently of another belt of the unit. To ensure accurate positioning of the belts 108, the flighted belts may be timing belts with a belt tooth pitch. The drive motor 116 may include a drive shaft 122 that includes a main drive sprocket or pulley 124 that drives the corresponding flighted belt 108. The drive shaft 122 may also include a number of idler pulleys 126 to accommodate the parallel routing of the other flighted belts 108 of the unit 102,104. The drive shaft 122 of one drive motor 116 may be spaced from the drive shaft of another motor to define the routing 110 of the belts 108 in the unit 102,104. FIGS. 3-5 omit some of the product supports for clarity. FIGS. 3-5 show a full set of product supports that are mounted to one belt, and only those product supports that are mounted to other belts which are located within or near the process zone for the particular instant in time shown in the figures. FIG. 6 shows all of the product supports that are mounted to all of the belts.

Sequentially, the product supports 120 of the flighted belts 108 of a unit 102,104 engage the ribbon 14 and convey the ribbon through the process zone 112. The control 118 for each drive motor 116 for a corresponding flighted belt 108 is configured to optimally position the product supports 120 of the belts 108 to carry the ribbon 14 in the process zone 112. The process zone 112 may be used for cutting the ribbon 14 or performing another operation on the ribbon or a clip 15 of the ribbon, for instance, stacking, packaging, wetting, etc. When the saw 12 is used in line with the conveyor system for cutting the ribbon 14 into clips in the process zone 112, the control 118 for each drive motor 116 for a corresponding flighted belt 108 is configured to optimally position the product supports 120 of the belts to carry the ribbon and the clips 15 cut therefrom through the process zone from an infeed belt conveyor 130 to an outfeed belt conveyor 132.

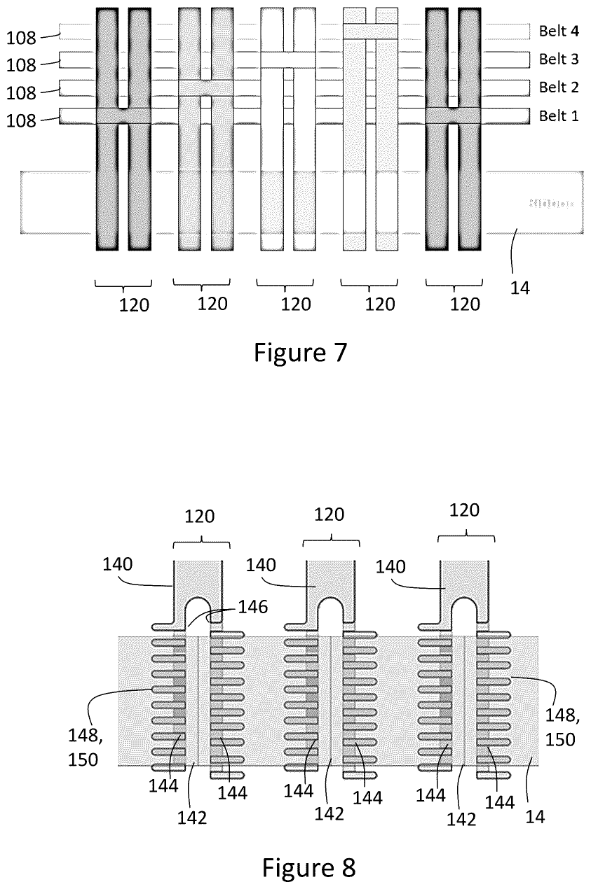

Referring to FIG. 7, the product supports 120 are mounted on the belts 108 in an alternating fashion such that adjacent supports are on adjacent belts. Preferably, at least two product supports 120 are provided for each belt 108 of a respective unit 102,104; more preferably, at least three product supports are provided for each belt of a respective unit; even more preferably, at least four product supports are provided for each belt of a respective unit; and even more preferably, at least five product supports are provided for each belt of a respective unit. The pitch between the product supports 120 (the “support pitch”) on each belt is selected such that the support pitch is an even multiple of the belt tooth pitch, and an available belt length is an even multiple of the support pitch. In one example, a belt 108 may have a length of 3360 mm, a support pitch of 672 mm, a tooth pitch of 14 mm corresponding to five product supports 120 equally spaced along the belt. By way of example and not in any limiting way, the width of a product support 120 may be 135 mm and the spacing between each of the five product supports on a 3360 mm belt length may be 537 mm.

As shown in the drawings, the upper and lower units 102,104 may each have four belts 108 that have a common routing 110 and wrap around four common drive axes. The drive axes are defined by the spaced apart drive motors 116 and corresponding drive shafts 122. Preferably, at least three belts 108 are provided in each unit; and more preferably, at least four belts are provided in each unit. Each drive shaft 122 is driven by a drive motor and gearbox arrangement. One sprocket or pulley 124 on each drive shaft 122 is keyed to the shaft corresponding to the motor and driven belt combination, while other pulleys or sprockets 126 may be arranged on the shaft as idlers to freely rotate on the drive shaft and to accommodate the parallel routing 110 of the other belts of the unit. The drive motor may be a Rockwell Automation Kinetix VPL Low-inertia Servo Motor, and the gearbox may be a Wittenstein low-backlash planetary gearbox.

The ribbon enters the saw from an upstream pull station (not shown) and is carried to the upper and lower units 102,104 by the infeed conveyor 130. The infeed conveyor 130 extends into the process zone 112. When the saw 12 is deployed in the process zone 112 for cutting the ribbon 14, the infeed conveyor 130 ends just upstream of the possible extent of the path of the saw blade 52. This ensures that the ribbon 14 is fully supported by the product supports 120 during the transition from the infeed conveyor 130 to the process zone 112. Similarly, the outfeed conveyor 132 extends from the process zone 112. When the saw 12 is deployed in the process zone 112 for cutting the ribbon, the outfeed conveyor 132 begins at the furthest extent of the path of the saw blade 52 to the downstream end of the saw. This ensures a seamless transition of ribbon 14 from the process zone 112 to the outfeed conveyor 132 and ensures the stacks or clips 15 are fully supported from the product supports 120 to the outfeed conveyor.

The product support 120 is operatively mounted to a respective flighted belt 108 with a mount extension 140. The length of the mount extension 140 is sized to accommodate the location of the belt 108 relative to the process zone 112. That is, the product supports 120 of the belt closest to the process zone have a shorter mount extension 140 than the product supports of the belts further from the process zone. When the process zone 112 includes the saw 12 for cutting the ribbon 14, the product support 120 may include a saw blade pass-through slot 142. In one such configuration, the product support 120 is comprised of two spaced apart cantilevered support arms 144. The spaced apart support arms 144 may be separately attached to the respective flighted belt 108 in a spaced apart manner to define the blade pass-through blade slot 142. For instance, the arms 144 comprising the product support 120 may have an inward facing lateral side 146 and an outward facing lateral side 148, and the inward facing lateral side 146 of one arm 144 faces the inward facing lateral side of the other arm and defines the pass-through blade slot 142. The outward facing lateral side 148 of each arm of the product supports of the belts 108 of the unit 102,104 may have projecting fingers 150. The projecting fingers 150 of the arm 144 may be arranged and configured for one product support 120 on one belt 108 to interdigitate with another product support on another belt. The fingers 150 may also increase the support on the ribbon and clips 15 while allowing the arms of adjacent supports to interleave as is necessary with the infeed and outfeed conveyors 130,132. The outer facing lateral sides 148 of the support arm may be radiused or relieved to allow the support arm 120 to better travel around the pulleys 114 that define the process zone 112 of the upper and lower units 102,104. Additionally, or in the alternative, one or both of the arms 144 of the product support 120 may have a longitudinal groove 152 defining first and second portions of the arm, and the first portion may be pivotable relative to the second portion about the longitudinal groove. In an alternative to the longitudinal groove, one or both of the arms 144 of the product support 120 may comprise two portions, each of which is separately mounted to the belt—in other words, the longitudinal groove in this alternative cuts completely through one or both of the arms 144. In a further alternative, one or both of the arms 144 of the product support 120 may comprise more than two portions, each of which is separately mounted to the belt.

In a configuration with the saw 12, a portion of the routing 110 of the belts of each of the upper and lower units are arranged in parallel so that the product supports 120 of the belts 108 of the units 102,104 translate through the process zone centered on the blade path. The product supports 120 are in contact with the ribbon and clips 15 from the inlet to the outlet of the process zone 112. The belt speed in the process zone 112 is synchronized with the ribbon speed. The product supports 120 of the upper and lower units 102,104 enter the process zone 112 in a synchronized and aligned manner with a speed matching the speed of advancement of the ribbon 14.

The length of the process zone 112 is selected taking into consideration geometric variables. The controller 118 has a processor 160 and memory 162 that stores a motion profile for each belt 108. The motion profile of a belt 108 of a respective unit 102,104 is configured so the belt has only one product support 120 in contact with the ribbon 14 at one time. As the product support 120 exits the process zone 112, the belt 108 has non-synchronous speed with the ribbon 14 such that the control can drive the motor and the belt to position another product support of the belt for entry into the process zone at the proper time. Accordingly, the motion profile for a belt may be modeled using a cam profile. The length of the process zone may be configured such that the cam slave distance is sufficient to achieve the dynamic performance targets.

The cam profiles of the belts 108 are such that as a product support 120 of one belt exits the process zone 112 and no longer makes contact with the clip 15 that the product support supported through the cut, another belt aligns its product support optimally on the ribbon to support the ribbon as it enters the process zone. Accordingly, each belt has the same cam profile, but the cam profile of one belt is phased offset from the cam profile of another belt according to the clip cut length and the overall width of the product supports. The cam profiles of the belts produce motion where the ribbon/clips are continually supported by a portion of the product supports of the belts, while product supports not in contact with the ribbon or clips 15 are advanced or retarded along the routing of the belts into position for their next support of the ribbon upon entry into the process zone.

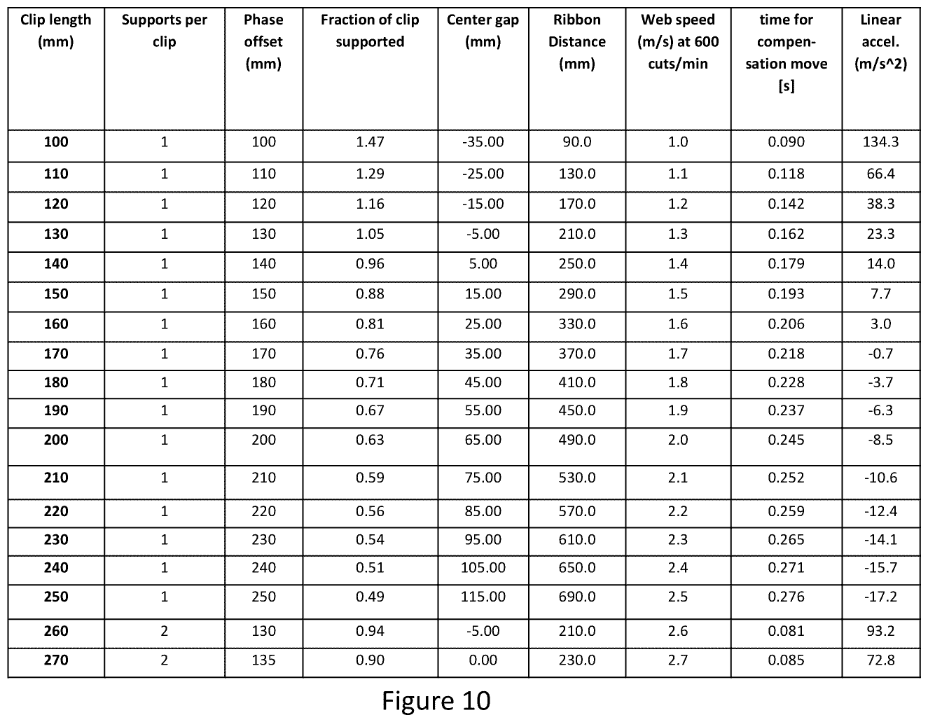

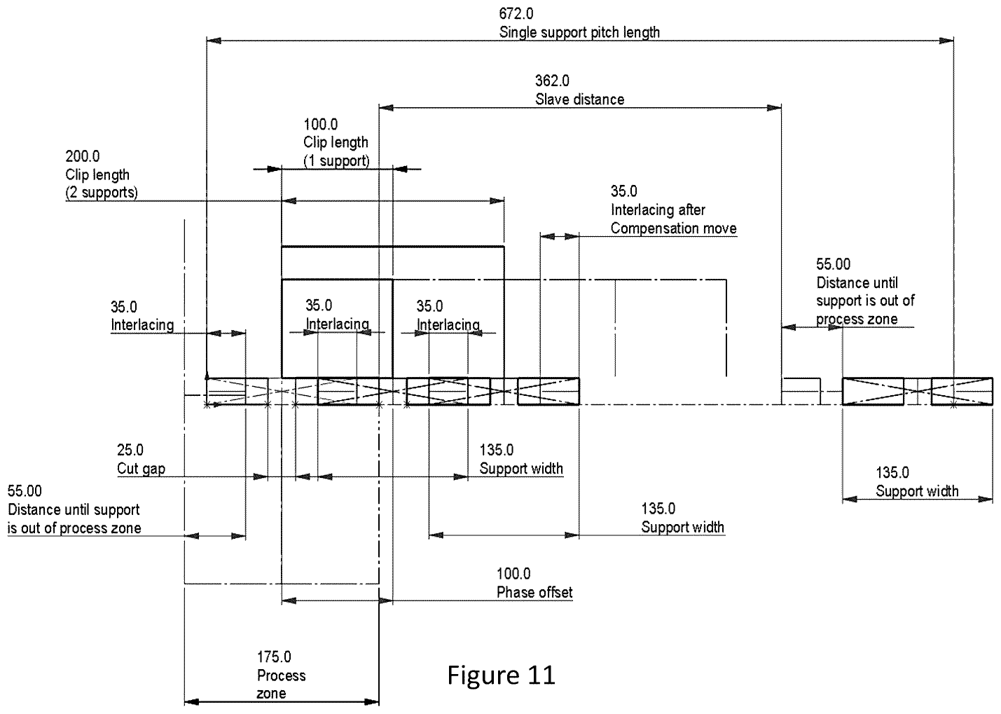

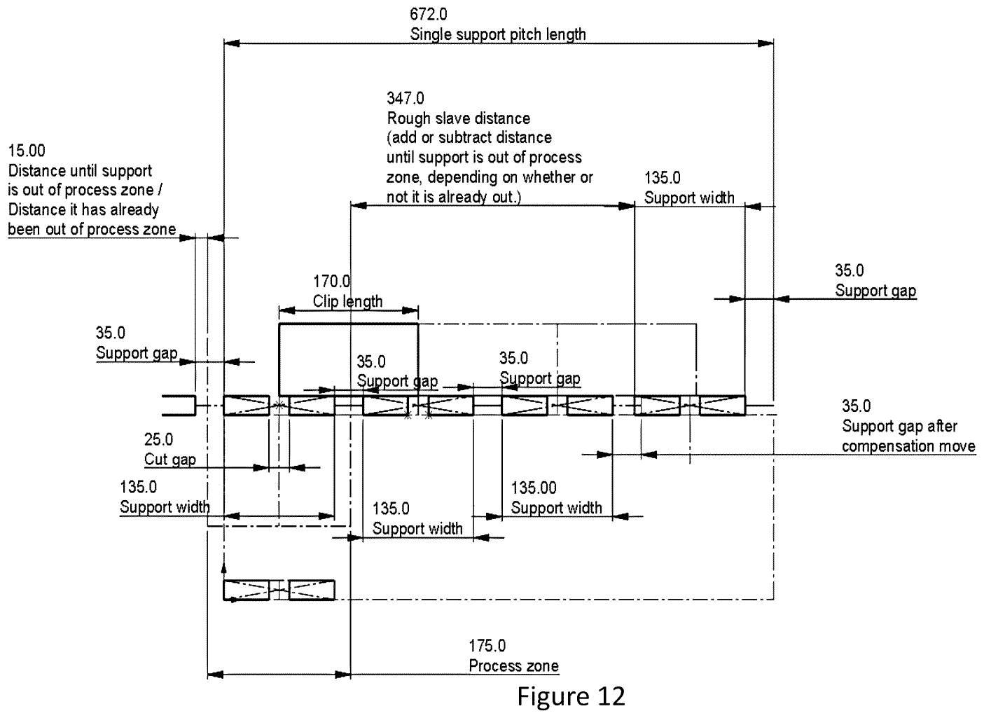

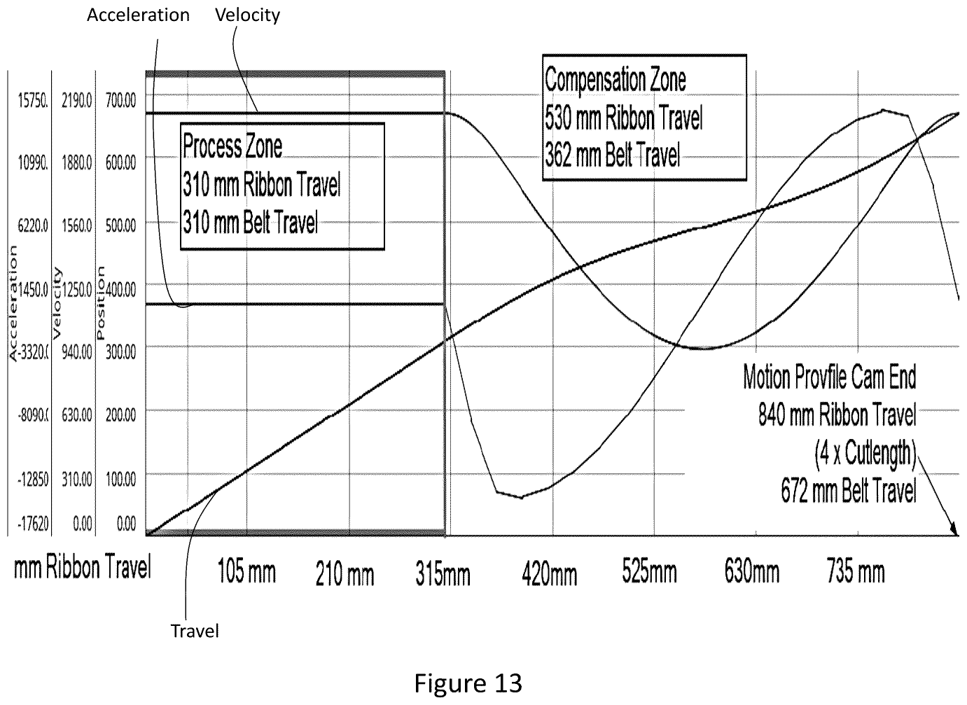

Accordingly, the cam profile for the belt motion is a function of the geometry of the product support, the length of the process zone, and the number of belts. FIGS. 10-13 illustrate geometric variables and motion profiles of product supports as the product supports enter and leave the process zone. The cam profile of the belt is comprised of two sections: motion in the process zone, and motion in compensation zone. The slave distance (the distance of belt travel over which a product support can be accelerated or decelerated in order to be at the correct phase offset when the product support enters the process zone) in each of these sections is determined solely by the previously mentioned variables and is constant for all lengths of clips cut from the ribbon. However, the master distance (“ribbon distance”) available for each zone or distance traveled by the ribbon during the cam profile is a function of the cut length as well as the geometric variables that define the number of supports per clip and the phase offset, the phase offset being defined as the desired distance between adjacent supports while the supports are within the process zone. The number of supports per clip is selected to keep the phase offset as close as possible to the natural pitch, which is the pitch between adjacent supports on adjacent belts when all supports are equally spaced. With a belt length of 3360 mm, a belt tooth pitch of 14 mm, a support pitch of 672 mm based on 5 product supports per belt, 4 belts, and a product support width of 135 mm, there may be a 175 mm process zone (which equates to a belt travel within the process zone of 310 mm when the 135 mm support width is added), a 362 mm compensation zone, a natural pitch of 168 mm, and a 362 mm slave distance in the compensation zone. The cam master distance, or distance the ribbon moves while the belt is in the compensation zone, is summarized in the table of FIG. 10. The acceleration required to move the product support within the compensation zone is summarized in the table of FIG. 10. An exemplary motion profile is shown in FIG. 13. When the product support needs to be advanced (i.e., the slave distance exceeds the master distance) the acceleration is positive; when the product support needs to be retarded (i.e. the master distance exceeds the slave distance) the acceleration is negative. When the clip length is the same as the natural pitch, and there is one product support per clip, the acceleration is zero. At certain clip lengths it may be necessary to support the clip 15 with a product support of one belt and a product support of another belt, and a pass-through blade slot may be formed by a gap between the two product supports (that is, the outer facing lateral side of one product support and the outer facing lateral side of the other product support in the process zone (See. FIG. 6). FIG. 11 illustrates product supports having a target phase offset which results in interdigitated (interlaced) adjacent product supports within the process zone whereas FIG. 12 illustrates product supports having a target phase offset which results in gaps between adjacent product supports within the process zone. Making reference to FIG. 11, the product supports may interleave or interdigitate to fully support the clips cut from the ribbon. The “center gap” column in the table of FIG. 10 indicates the overlap (negative) or gap (positive) between adjacent supports as a function of the cut length. The calculation of the product support pitch, or belt phase offset, may be altered to increase the amount of support on the clips. With product supports having a 135 mm width, longer cut lengths, for example 260 mm or longer, may include an additional support. With the proposed configuration, the gap between supports to allow the blade to pass through is 25 mm. The choice of how many product supports to use for a particular clip cut length may be configurable in the product manufacturing plan or product recipe. Products that particularly need additional support may be configured as such potentially with an adjustment of speed of advancement of the ribbon.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

What is claimed is:

1. A conveyor system for moving folded, stacked webs of material, the conveyor system comprising:
a first unit having a plurality of belts, each belt in the plurality of belts being driven by a respective motor, each motor having a drive shaft with a pulley configured to drive the respective belt, the drive shaft of one motor being spaced from the drive shaft of another motor to define a routing of the belts in the first unit, the belts travelling in parallel paths along the routing of the first unit, each belt being independently movable relative to another belt along the routing of the first unit, each belt having at least two product supports, the plurality of belts of the first unit comprising at least three belts;
a second unit opposite of the first unit, the second unit forming a process zone with the first unit;
wherein the product support of one of the belts of the first unit engages one side of the folded, stacked web material to be conveyed on the conveyor system in the process zone, and the second unit engages an opposite side of the folded, stacked web material to be conveyed on the conveyor system in the process zone; and
wherein the motors of the first unit are each adapted and configured to move their respective belts in a manner such that the product supports of the first unit move in a synchronized manner from an inlet of the process zone to an outlet of the process zone at an adjustable interval.

2. The conveyor system of claim 1 wherein the second unit further comprises a plurality of belts, each belt in the plurality of belts being driven by a respective motor, each motor having a drive shaft with a pulley configured to drive the respective belt, the drive shaft of one motor being spaced from the drive shaft of another motor to define a routing for the belts in the second unit, the belts travelling in parallel paths along the routing in the second unit, each belt being independently movable relative to another belt along the routing in the second unit, each belt having at least two product supports, the plurality of belts of the second unit comprising at least three belts;
wherein the second unit engages the opposite side of the folded, stacked web material to be conveyed on the conveyor system in the process zone with a product support of one of the belts of the second unit; and
wherein the motors of the second unit are each adapted and configured to move their respective belts in a manner such that the product supports of the belts of the second unit move in a synchronized manner from the inlet of the process zone to the outlet of the process zone at an adjustable interval.

3. The conveyor system of claim 2 wherein at least one of the first unit and the second unit are adapted and configured for movement relative to the other to adjust the distance between the units.

4. The conveyor system of claim 2 wherein the drive shafts of the motors of the first unit define common axes of rotation in the routing of the belts of the first unit.

5. The conveyor system of claim 2 wherein the drive shafts of the motors of the second unit define common axes of rotation in the routing of the belts of the second unit.

6. The conveyor system of claim 1 further comprising a saw having a blade adapted and configured for orbital movement relative to the conveyor system between adjacent arms of the product supports during cutting of the folded, stacked web material to be conveyed on the conveyor system.

7. The conveyor system of claim 6 wherein the product support of one of the belts of the first unit and the product support of one of the belts of the second unit move in the process zone in a synchronized and aligned manner with an interval corresponding to a length of the folded, stacked web material to be cut with the saw blade.

8. The conveyor system of claim 7 wherein the interval of the product supports of the belts of the first unit and the interval of the product supports of the belts of the second unit provide clearance between the saw blade and the product supports of the respective belts when cutting the folded, stacked web material with the saw blade.

9. The conveyor system of claim 7 wherein the product supports of the belts of the first unit and the product supports of the belts of the second unit are adapted and configured to move in a continuous manner when advancing the folded, stacked web material to be cut with the saw.

10. A conveyor system for moving folded, stacked webs of material, the conveyor system comprising:
a process zone having an inlet and an opposite outlet and a length extending between the inlet and the outlet, the process zone being disposed between primary and secondary units;
the primary unit comprising:
a primary first product support adapted and configured to engage the ribbon when the ribbon enters the inlet of the process zone and convey the ribbon toward the outlet of the process zone, the primary first product support being operatively connected to a primary first continuous loop driven by a primary first drive motor;
a primary second product support adapted and configured to engage the ribbon when the ribbon enters the inlet of the process zone and convey the ribbon toward the outlet of the process zone, the primary second product support being operatively connected to a primary second continuous loop driven by a primary second drive motor;
a primary third product support adapted and configured to engage the ribbon when the ribbon enters the inlet of the process zone and convey the ribbon toward the outlet of the process zone, the primary third product support being operatively connected to a primary third continuous loop driven by a primary third drive motor; and
a controller coupled to the primary first drive motor, the primary second drive motor, and the primary third drive motor, the controller being adapted and configured to control the primary first drive motor, the primary second drive motor, and the primary third drive motor independently of each other, the controller being adapted and configured to control: (i) the primary first drive motor to move the primary first continuous loop and the primary first product support operatively connected thereto from the inlet of the process zone to the outlet of the process zone, (ii) the primary second drive motor to move the primary second continuous loop and the primary second product support operatively connected thereto from the inlet of the process zone to the outlet of the process zone, and (iii) the primary third drive motor to move the primary third continuous loop and the primary third product support operatively connected thereto from the inlet of the process zone to the outlet of the process zone.

11. The conveyor system of claim 10 wherein the secondary unit further comprises:
a secondary first product support adapted and configured to engage the ribbon when the ribbon enters the inlet of the process zone and convey the ribbon toward the outlet of the process zone, the secondary first product support being operatively connected to a secondary first continuous loop driven by a secondary first drive motor;
a secondary second product support adapted and configured to engage the ribbon when the ribbon enters the inlet of the process zone and convey the ribbon toward the outlet of the process zone, the secondary second product support being operatively connected to a secondary second continuous loop driven by a secondary second drive motor;
a secondary third product support adapted and configured to engage the ribbon when the ribbon enters the inlet of the process zone and convey the ribbon toward the outlet of the process zone, the secondary third product support being operatively connected to a secondary third continuous loop driven by a secondary third drive motor;
wherein the controller is coupled to the secondary first drive motor, the secondary second drive motor, and the secondary third drive motor, the controller being adapted and configured to control the secondary first drive motor, the secondary second drive motor, the secondary third drive motor independently of each other, the controller being adapted and configured to control: (iv) the secondary first drive motor to move the secondary first continuous loop and the secondary first product support operatively connected thereto from the inlet of the process zone to the outlet of the process zone, (v) the secondary second drive motor to move the secondary second continuous loop and the secondary second product support operatively connected thereto from the inlet of the process zone to the outlet of the process zone, and (vi) the secondary third drive motor to move the secondary third continuous loop and the secondary third product support operatively connected thereto from the inlet of the process zone to the outlet of the process zone.

12. The conveyor system of claim 11 further comprising a saw having a blade, the saw blade being positionable in the process zone adjacent product supports of the continuous loops of the primary and secondary units and configured to cut the ribbon in the process zone.

13. The conveyor system of claim 12 wherein the controller is adapted and configured to control the primary first drive motor and the secondary first drive motor so as to advance in a synchronized and aligned manner the respective primary first product support and the secondary first product support from the inlet of the process zone to the outlet of the process zone with an interval corresponding to a length of the folded, stacked web material to be cut with the saw blade.

14. The conveyor system of claim 12 wherein the controller is adapted and configured to control the primary second drive motor and the secondary second drive motor so as to advance in a synchronized and aligned manner the respective primary second product support and the secondary second product support from the inlet of the process zone to the outlet of the process zone with an interval corresponding to a length of the folded, stacked web material to be cut with the saw blade.

15. The conveyor system of claim 12 wherein the controller is adapted and configured to control the primary third drive motor and the secondary third drive motor so as to advance in a synchronized and aligned manner the respective primary third product support and the secondary third product support from the inlet of the process zone to the outlet of the process zone with an interval corresponding to a length of the folded, stacked web material to be cut with the saw blade.

16. The conveyor system of claim 11 wherein at least one of the primary unit and the secondary unit are adapted and configured for movement relative to the other to adjust the distance therebetween.

17. The conveyor system of claim 11 wherein the drive motors of at least one of the primary unit and secondary unit have drive shafts that define common axes of rotation of the belts of the respective unit.

18. The conveyor system of claim 11 wherein the product supports for each belt of at least one of the first unit and second unit each comprise two spaced apart and parallel arms cantileverly attached to the respective belt.

19. The conveyor system of claim 18 wherein the arms comprising the product supports for each belt of the respective unit each have an inward facing lateral side and an outward facing lateral side, the inward facing lateral side of one arm facing the inward facing lateral side of the other arm, the outward facing lateral side of each arm having projecting fingers, the projecting fingers of each arm being configured for one product support on one belt to interdigitate with another product support on another belt.

20. The conveyor system of claim 18 wherein the arms comprising the product supports for each belt of the respective unit each have a longitudinal groove defining first and second portions of the arm, the first portion is pivotable relative to the second portion about the longitudinal groove.
